(19) United States
(12) Patent Application Publication
(10) Pub. No.: US 2010/0076740 A1
(43) Pub. Date: Mar. 25, 2010

(54) SYSTEM AND METHOD FOR WELL TEST DESIGN AND INTERPRETATION

(75) Inventors: Fikri Kuchuk, Meudon (FR); Rajat Sood, Antony (FR); Younes Jalali, St. Nom la Breteche (FR); Shahram Amini, Paris (FR); Mohammad Zafari, La Defense Cedex (FR)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 12/555,049

(22) Filed: Sep. 8, 2009

Related U.S. Application Data
(60) Provisional application No. 61/095,158, filed on Sep. 8, 2008.
(60) Provisional application No. 61/104,050, filed on Oct. 9, 2008.

(51) Int. Cl. G06G 7/50; E21B 47/10

(52) U.S. Cl. 703/10; 702/12

(57) ABSTRACT

A method and system for well test design and interpretation, comprising a testing manager system, which includes at least one of testing hardware and gauge metrology; a geological model coupled to the testing manager system; a dynamic and static engineering data acquisition system coupled to the geological model; and a reservoir modeling system coupled to the dynamic and static engineering data acquisition system to generate a reservoir model. Also provided is a method and computer program for controlling, driving, and enabling the devices, systems, and subsystems presented herein through interaction with a human user, or the like.

### CROSS-REFERENCE TO RELATED APPLICATION

The present application is based on and claims priority to U.S. Provisional Patent Application No. 61/095,158, filed Sep. 8, 2008, and U.S. Provisional Patent Application No. 61/104,050, filed Oct. 9, 2008.

### TECHNICAL FIELD

The present invention generally relates to methods and systems for well testing, and more particularly to a system and method for well test design and interpretation.

### BACKGROUND ART

Crucial decisions relating to well production efficiency, operations, and safety, well workover, and reservoir management can require huge amounts of data, including measurements of well downhole and surface pressure, temperature, flow rate, etc. However, conventional systems and methods suffer from not being able to efficiently process the acquired data, including downhole pressure measurement interpretation.

Moreover, in the traditional process of design, implementation, and interpretation of a well test, various processing steps or stages are performed separately and advances in new technologies have enabled optimization of each individual stage in order to achieve the best results at each stage, but separately from other stages of the operations. Accordingly, although there have been software and platforms developed for each stage, an overall system and method is needed to integrate all of the suitable well testing processes, from design to interpretation, in a single platform.

### SUMMARY OF THE INVENTION

Therefore, there is a need for a method and apparatus (which also may be referred to herein as a “system”) that addresses discovered problems with existing systems and methods for well testing. The above and other needs and problems are addressed by the present invention, exemplary embodiments of which are presented in connection with the associated figures. The present invention provides an improved method and system for well test design and interpretation, referred to as a Test Design and Interpretation Process (TDIP), that allows an operator to make crucial decisions related to well production efficiency, operations, and safety, well workover, and reservoir management based on real-time measurements of well downhole and surface pressure, temperature, flow rate, and the like, and advantageously integrates all of the suitable well testing processes, from design to interpretation, in a single platform. Data is acquired from various tools, such as a multiphase flowmeter, e.g., Schlumberger's Vx technology, capable of measuring the flow rate and the oil, water and gas content of the well effluent, and the downhole and surface pressure during reservoir testing. The data is interpreted real time to enable production and reservoir engineers and managers to optimize well completion, perforation, lift, production, recovery, and the like. As each well represents a large investment in drilling and completion, the reservoir and well knowledge gained from dynamic testing data integrated by the TDIP, advantageously, can help to reduce the number of development wells employed, and provide for a better prediction of field performance, the ability to pinpoint future infill drilling opportunities, and the like.

In an exemplary embodiment, the exemplary system and method can include the TDIP used in conjunction with a Testing Manager Platform and Real-Time data acquisition system to enable exploration and production companies and testing reservoir engineers to enhance and add value to well testing operations, test design, interpretation, and successful completion of a well test. Furthermore, the exemplary system and method help to reduce uncertainty in complex geological systems. The TDIP synthesizes the well test measurements, such as pressure, flow rate, temperature, and the like, with a geological model of the reservoir to model these measurements and anticipate the encounter of geological features, such as faults, fracture, and the like, while testing, in order not to terminate well testing prematurely. Advantageously, the novel well test design and interpretation system and method is continuous until the termination of the well test, wherein test data are received from various sensors via the acquisition system into the Testing Manager. The reservoir model is continuously updated as data comes in via the TDIP, wherein the Testing Manager provides real-time connections to design, interpretation, other toolboxes, and the like. The TDIP combined with the Testing Manager enables faster decision making with the potential to identify and reduce nonproductive testing time with test design and interpretation. Advantageously, the TDIP can be used to update the model in real time, enabling faster decision making and reducing testing time, and saving time and money.

Accordingly, in an exemplary aspect, there is provided a method, system and apparatus for well test design and interpretation, including a testing manager system, which includes at least one of testing hardware and gauge metrology; a geological model coupled to the testing manager system; a dynamic and static engineering data acquisition system coupled to the geological model; and a reservoir simulation system coupled to the dynamic and static engineering data acquisition system to generate a reservoir response.

In another exemplary aspect, there is provided a method and computer program product for well test design and interpretation, including generating a test plan and an initial reservoir model based on at least one of an expected reservoir model, rock properties, fluid properties, and/or metrology; generating data streams based on the test plan from real/near-real-time, surface, downhole, and/or manual data sources; generating an aggregated data stream based on quality control/assurance on the data streams; generating data for optimization based on the aggregated data stream and simulated downhole data sent to the quality control/assurance; modeling/interpreting of the optimization data including reservoir simulation and modeling to determine if test objectives are met for terminating/continuing the test plan and generating data sent to the generating data for optimization for modifying assumptions therein; and/or reporting data received from the modeling/interpretation when terminating the test plan.

Still other aspects, features, and advantages of the present invention are readily apparent from the entire description thereof, including the figures, which illustrate a number of exemplary embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 depicts an exemplary Test Design and Interpretation Process (TDIP) for well test design and interpretation;

FIG. 2 depicts an exemplary Testing Manager employed for the well test design and interpretation of FIG. 1;

FIG. 3 depicts an exemplary Geological Model employed for the well test design and interpretation of FIG. 1;

FIG. 4 depicts an exemplary Dynamic and Static Engineering data employed for the well test design and interpretation of FIG. 1;

FIG. 5 depicts an exemplary Reservoir Modeling employed for the well test design and interpretation of FIG. 1;

FIG. 6 depicts an exemplary Test Operation and Data Acquisition for well test design and interpretation;

FIG. 7 depicts an exemplary Real Time Wellsite and Remote Site Interpretation for well test design and interpretation; and

FIG. 8 depicts an exemplary Final Analysis, including Verification, Uncertainty analysis, Nodal analysis, and Reserves Estimation for well test design and interpretation.

FIG. 9 depicts an exemplary flowchart of a Test Design Segment of the exemplary Testing Design and Interpretation Process (TDIP);

FIG. 10 depicts an exemplary overall TDIP workflow;

FIG. 11 depicts an exemplary flowchart of a QA/QC process step of the TDIP workflow of FIG. 10;

FIG. 12 depicts an exemplary flowchart of a Data Processing process step of the TDIP workflow of FIG. 10; and

FIG. 13 depicts an exemplary flowchart of a Modeling/Interpretation process step of the TDIP workflow of FIG. 10.

### DETAILED DESCRIPTION

Various embodiments and aspects of the invention will now be described in detail with reference to the accompanying figures. The terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

An exemplary Test Design and Interpretation Process (TDIP) includes analytical interpretation methodology for real-time well monitoring and deriving reservoir characteristics from analysis of transient pressure data obtained by downhole gauges, in association with permanent (or e.g., regular) surface or downhole data (e.g., Vx rate data from Schlumberger's Vx technology). The methodology is based on a continuous analysis of the pressure and rate data in decline-curve analysis for wells with a variable downhole flowing pressure, or through more sophisticated models that can be based on the ones used in well testing analysis. Because the interpretation is conducted while continuing production, the exemplary system and method are particularly well suited for a well or group of wells under extended testing, which are equipped with downhole gauges and are flowing through surface separation and metering systems.

To complement the real-time analytical interpretation methodology, continuous pressure and rate measurements at different well locations can be used to probe the reservoir to obtain its properties for history matching with a detailed reservoir simulator. Furthermore, because the data is dynamic and direct, pressure and production data, and pressure transient testing, which can be performed cost-effectively and frequently, for example, with the Vx technology, can provide needed information for well productivity and dynamic reservoir description, for enabling efficient production and reservoir engineering decision making, and the like. Pressure testing can also show that a formation can flow and can provide productivity index, reservoir pressure, permeability, heterogeneity, and the like. Integrated by the TDIP, fluid-flow simulation, geology, time-lapse seismic images, geostatistics, rock physics, reflection seismology, and the like, can provide spatially distributed continuous pressure and flow rate measurements to enable continuous dynamic data for reservoir characterization at the well-to-well scale.

As pressure transient testing interpretation is still expert and experience intensive, the exemplary TDIP can be used to assist engineers' interpretation effort in a way that maximizes testing benefits to clients with well timed and verifiable results. With this novel system and method, recurring and easy tasks, such as sampling, data reduction, and the like, can be automated with overriding capabilities. On the other hand, uncertainties in reservoir models and non-uniqueness of the model, identification, and its estimates can be determined jointly by geoscientists and reservoir engineers by using automation and uncertainty systems. Because the novel system and method provides a most complete range of static and dynamic data at all suitable scales from wellhead to basins, the novel system and method can provide a unique advantage in Testing Services to obtain well productivity, to provide reservoir characterization and reserves estimation, to determine connected volume, and the like.

Accordingly, advantages of the TDIP method and system, include making the interpretation process seamless, using expertise and experience in real time but with a remote capability, maximizing interpretation process automation, facilitating testing decision making, such as termination of a test, and the like, in real time, quantifying uncertainty in the geological model and its estimates, accurate test design and planning, real-time data monitoring, well lift and production optimization, data access at any suitable time and at any suitable place, and data validation, maintaining state-of-the-art expertise on the testing technology, validating reserves and productivity based on dynamic testing data, and the like.

Advantageously, the TDIP system and method can be web based, wherein the testing hardware, data, and models for the reservoir can be accessible to production companies, client testing engineers, designers, interpreters, and the like. Thus, the novel platform can provide a complete interpretation of pressure transient and flow rate data, and capture information at the end of the interpretation in a prompt, accurate and efficient manner. Automation and visualization can be an integral part of the novel platform.

The present invention includes recognition that in the coming years, real-time monitoring of well and reservoir data will play a central role for well productivity and reservoir management. Accordingly, it is very important to respond timely to solve reservoir problems, and well productivity and production assurance. For ensuring effective monitoring, the exemplary system and method provide real time interpretation via the TDIP, as monitoring systems evolve continuously, and can give a context for interpreting the significance of the data being monitored.

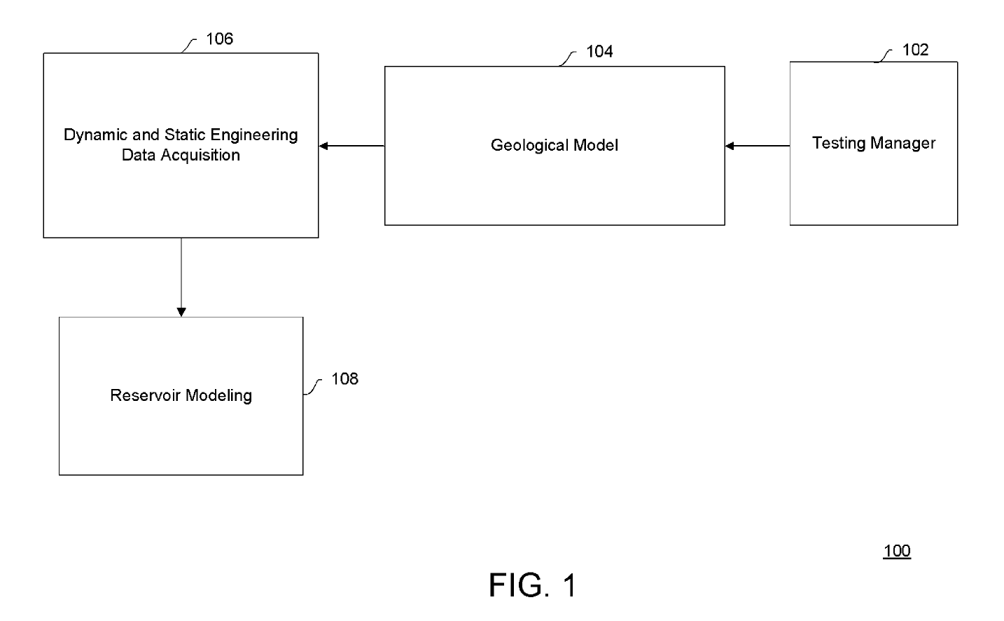

Referring now to the drawings, wherein like reference numerals designate similar or corresponding parts throughout the several views, and more particularly to FIGS. 1-13 thereof, there are illustrated an exemplary method and system for well test design and interpretation, according to exemplary aspects of the present invention.

FIG. 1 depicts the exemplary TDIP system and method 100 for well test design and interpretation. In FIG. 1, the exemplary system and method 100 includes a Testing Manager 102, including Testing Hardware and Gauge metrology, a Geological Model 104, such as a PETREL based geological model, Dynamic and Static Engineering Data Acquisition 106, and Reservoir Modeling 108.

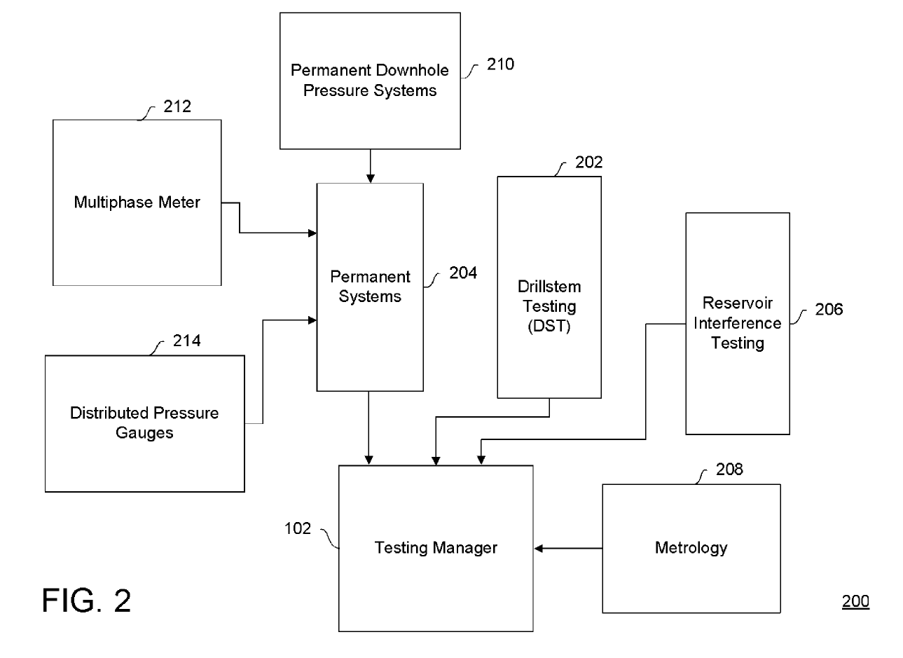

FIG. 2 depicts the exemplary Testing Manager 102, systems and processes 200 employed for the well test design and interpretation of FIG. 1. In FIG. 2, the exemplary Testing Manager 102 can receive data from various instrumentation, such as a Drillstem Testing (DST) 202, e.g., Schlumberger's DST, Permanent Systems 204, Reservoir Interference Testing 206, and Metrology 208. The Permanent Systems 204 can include Permanent Downhole Pressure systems 210, a multiphase meter 212, and Distributed Pressure Gauges 214, including Smart plugs, Smart casing, and the like.

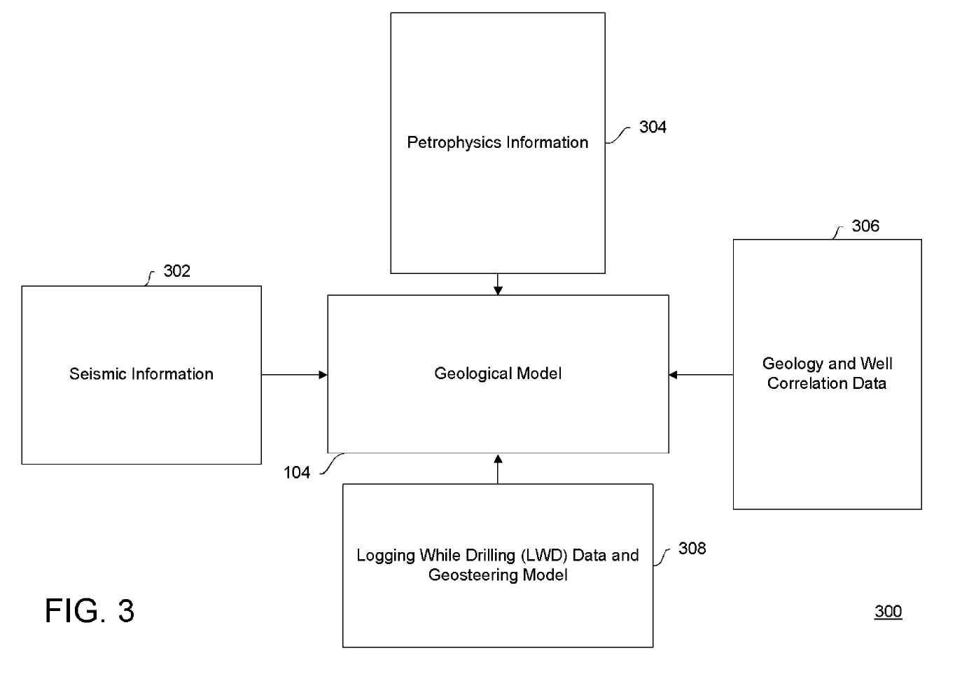

FIG. 3 depicts the exemplary Geological Model 104 systems and processes 300 employed for the well test design and interpretation of FIG. 1. In FIG. 3, the exemplary Geological Model 104 can be based on Seismic information 302, Petrophysics information 304, Geology and Well Correlation data 306, and Logging While Drilling (LWD) data and Geosteering model 308.

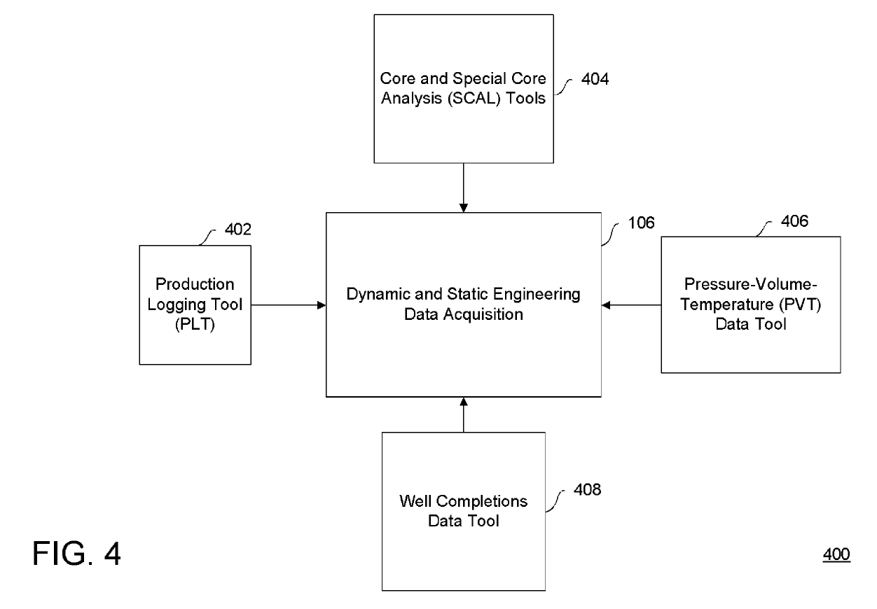

FIG. 4 depicts the exemplary Dynamic and Static Engineering Data Acquisition 106 systems and processes 400 employed for the well test design and interpretation of FIG. 1. In FIG. 4, the exemplary Dynamic and Static Engineering Data Acquisition 106 can include a Production Logging Tool (PLT) 402, Core and Special Core Analysis (SCAL) tools 404, Pressure-Volume-Temperature (PVT) data tool 406, and Well Completions data tool 408.

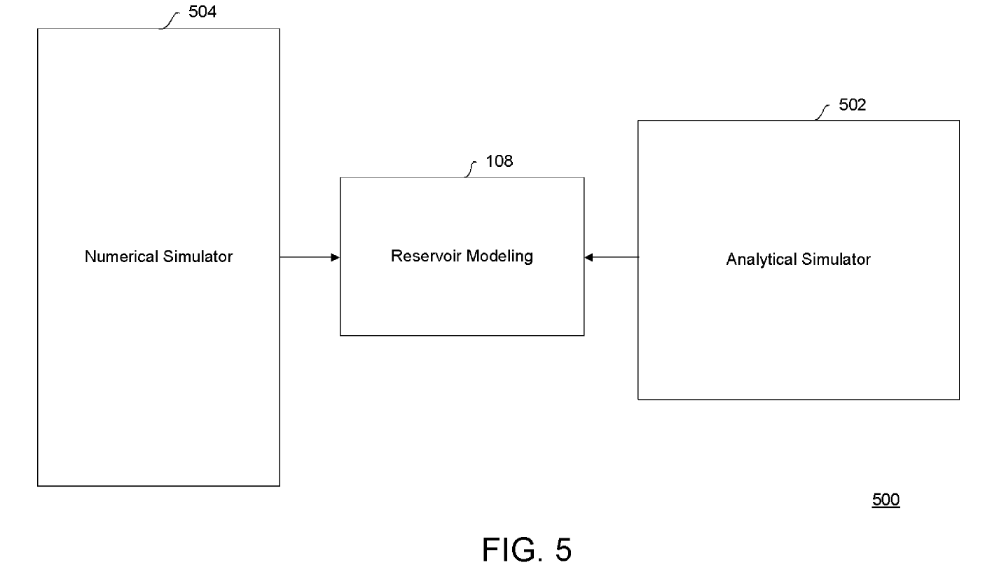

FIG. 5 depicts the exemplary Reservoir Modeling 108 systems and processes 500 employed for the well test design and interpretation of FIG. 1. In FIG. 5, the exemplary Reservoir Modeling 108 can include an Analytical Simulator 502 and a Numerical Simulator 504.

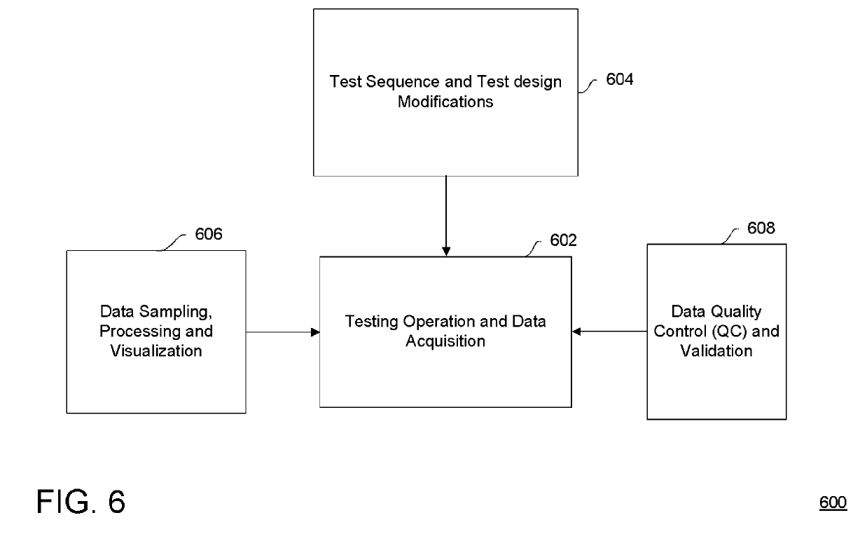

FIG. 6 depicts exemplary Testing Operation and Data Acquisition systems and processes 600 employed for well test design and interpretation processes. In FIG. 6, the exemplary Testing Operation and Data Acquisition systems and processes 600 can include Testing Operation and Data Acquisition 602, including Test sequence and Test design modifications 604, Data Sampling, Processing and Visualization 606, and Data Quality Control (QC) and Validation 608.

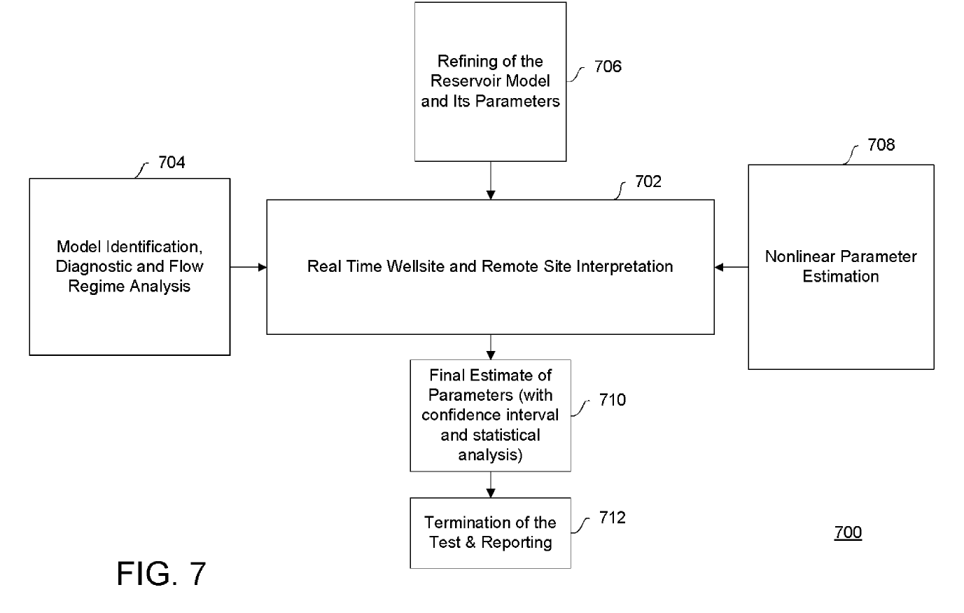

FIG. 7 depicts exemplary Real Time Wellsite and Remote Site Interpretation systems and processes 700 employed for well test design and interpretation. In FIG. 7, the exemplary Real Time Wellsite and Remote Site Interpretation systems and processes 700 can include Real Time Wellsite and Remote Site Interpretation 702, including Model identification, Diagnostic and Flow regime analysis 704, Refining of the Reservoir Model and Its Parameters 706 (e.g., Initialization, Conditioning, Calibrating, Scaling, Range, Weight Assigning, etc.), and Nonlinear Parameter Estimation 708 (e.g., History Matching) using Analytical and/or Numerical Reservoir Models and Least-Squares (L-S) and/or Maximum Likelihood (ML) Regression Techniques to generate a Final Estimate of Parameters 710 (e.g., with confidence interval and statistical analysis) and for Termination of the Test and Reporting 712.

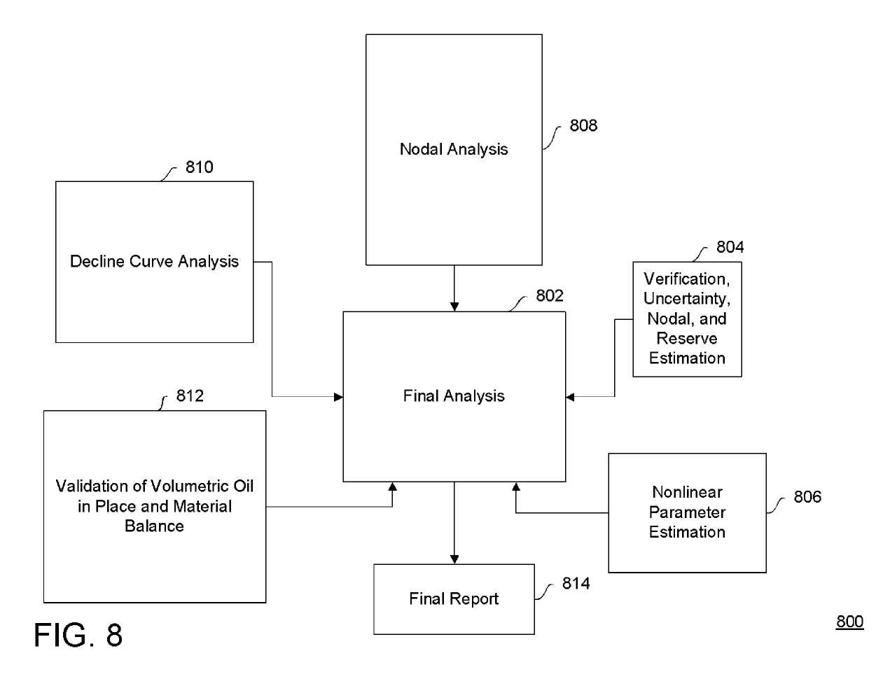

FIG. 8 depicts exemplary Final Analysis systems and processes 800, including Verification, Uncertainty, Nodal, and Reserve Estimation employed for well test design and interpretation. In FIG. 8, the exemplary Final Analysis systems and processes 800 can include Final Analysis 802, including Verification, Uncertainty Analysis, Nodal Analysis, and Reserve Estimation 804, based on Refining the Reservoir Model and Its Parameters 706, Nonlinear Parameter Estimation 806 using Analytical and/or Numerical Solutions of Reservoir Models and Least-Squares (L-S) and/or Maximum Likelihood (ML) Regression Techniques, Nodal Analysis 808, Decline Curve Analysis 810, and Validation of volumetric oil in place and Material Balance 812 to generate a Final Report 814.

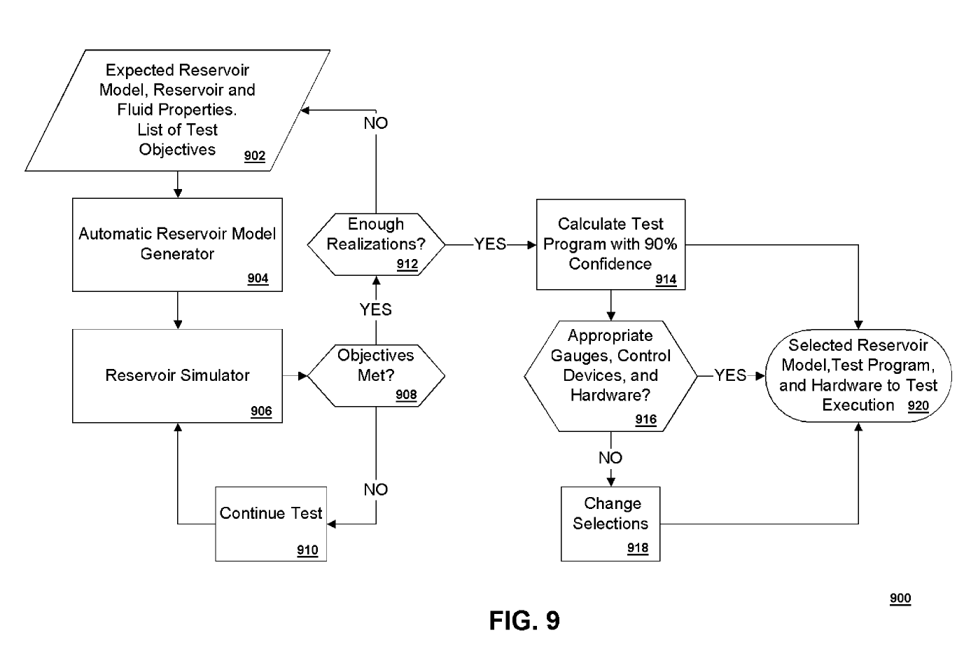

FIGS. 9-13 depict an exemplary embodiment of the Testing Design and Interpretation Process (TDIP) workflow, in combination with a real-time data acquisition system, enabling exploration and production, as well as reservoir testing engineers of service companies to enhance and add value to testing operations. The test design and its interpretation are considered as continuous processes, while the test data are received from the sensors via an acquisition system, until termination of the test.

The TDIP helps to reduce the uncertainties in complex geological systems. The reservoir model, which includes uncertainties and is used to design a test, is continuously updated, as data are received by the TDIP in real or near-real-time. The TDIP synthesizes measured data, such as pressure, temperature, and flow rates, with a geological model using simulation, and modeling and optimization tool boxes, integrated in the TDIP, and updates the reservoir model parameters and forecasts the model behavior to anticipated specific flow behavior.

The real-time downhole and surface data received by, and interpreted in the TDIP, enables production and reservoir managers and engineers to make crucial decisions related to production efficiency, operations, safety, well completion and workover, and reservoir management.

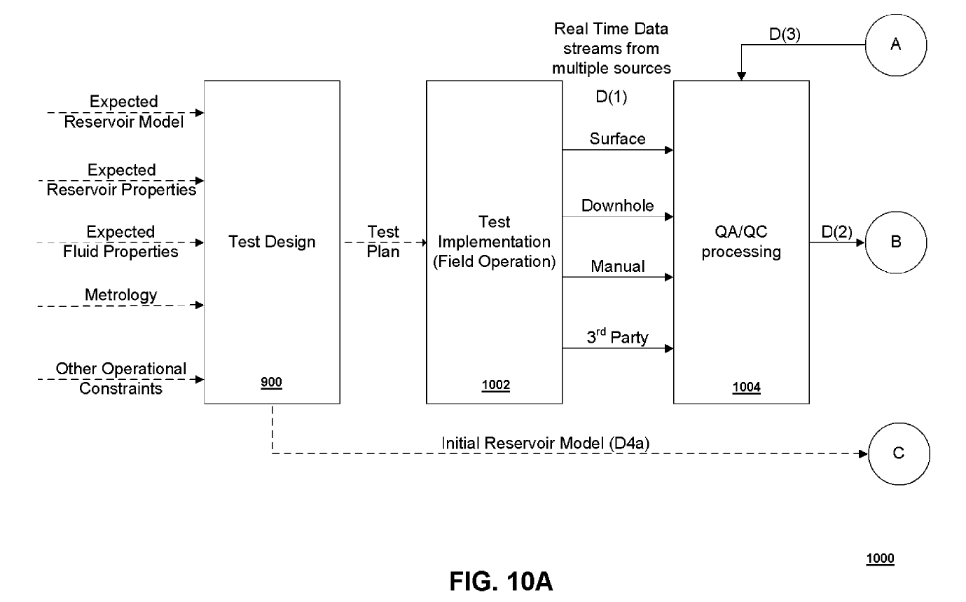

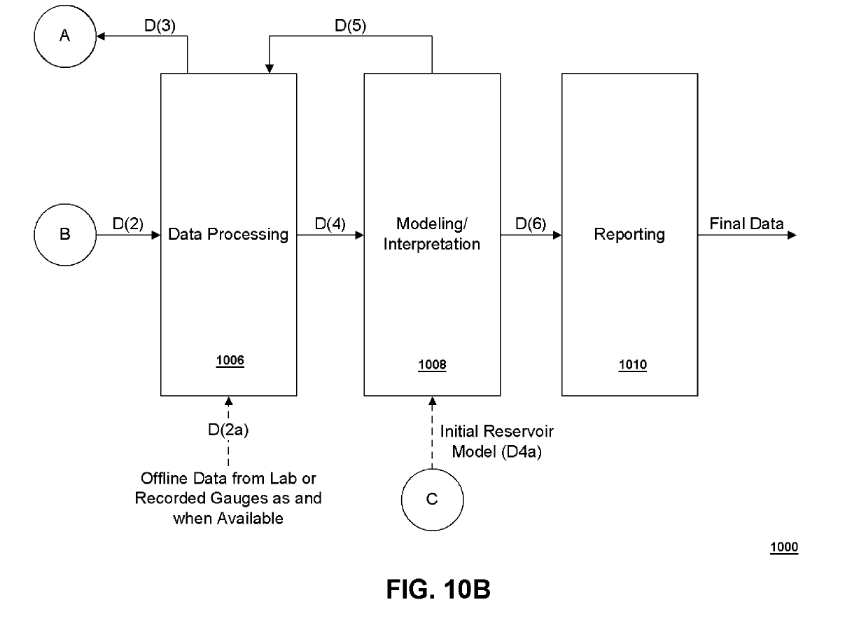

The present disclosure details the entire workflow of the TDIP in the design, acquisition and interpretation and describes the processes involved in detail. The overall TDIP Workflow is shown in FIG. 10, and includes a multi-step workflow including a preliminary design stage of FIG. 9, which includes steps and inputs employed for designing a well test operation prior to its implementation. Because of the high level of uncertainties about the reservoir and fluid properties, the output of the stage of FIG. 9 can include an expected distribution of test plans. The plan which guaranties, for example, with 90%-95% statistical confidence, achievement of all suitable test objectives, is then chosen for implementation.

In FIG. 9, the data input step 902 includes a list of test objectives, which can be a most important data input to the TDIP because the whole testing activities are planned and implemented to meet the objectives. Expected reservoir models are also provided to take into account expectation of the reservoir behavior from the points of view of various disciplines. The expected reservoir model input can be in the form of simple analytical models or more complicated numerical reservoir models derived from a more complex geological model. This can include any suitable information about the reservoir layering, existence of fractures and faults, and the like. In both cases, the TDIP platform provides an appropriate connection with either kind of simulator to facilitate data and results exchange before and during the test implementation. Expected reservoir properties also are provided along with their corresponding range of uncertainty. This provides the opportunity to run more realizations of the reservoir behavior and calculate the range of uncertainties on the total test duration needed to achieve the test objectives. Expected fluid properties also are provided along with their expected range of accuracy. Metrology, including specifications of the available gauges for a certain job, also is input to the TDIP prior to testing. According to an appropriate test design, a check is made as to whether or not the current measurement devices are capable of accurate data acquisition, to a level that is needed for accurate interpretation.

Based on the input data of step 902, a series of realizations of a well test are simulated and a series of total well test durations are generated at steps 904-920. This is done considering any suitable limitations in measurement devices. The output of this stage at step 920 is a distribution of total test duration, which enables the achievement of the test objectives with regard to the limitations in measurement systems. A decision is then made to select a test plan which can guarantee the achievement of the test objectives. Since a distribution of duration is available, selection of the test duration, and its corresponding test program, which provides at least 90% statistical confidence for meeting the test objectives, can be recommended. Advantageously, the TDIP provides an interactive workflow and the test program can be terminated earlier or extended beyond the base plan, depending on whether or not the test objectives are met.

During the test operation, there is a flow of dynamic data to the exemplary system, including dynamic pressure data. In a standard well test operation, pressure is measured downhole, at the wellhead and also at the separator point. More than one pressure gauge can be employed for downhole pressure (e.g., to check for data quality) and dynamic wellhead pressure (e.g., casing and tubing wellhead pressure). In the case of interference testing, input from nearby wells can also be employed. Temperature is also measured in more than one point, and for example can practically be measured wherever pressure is measured. Flow rates of fluid produced during the test are measured as accurate as possible and the production data is employed as a dynamic input to the TDIP platform. With respect to fluid properties, the TDIP receives input for continuous measurements of the fluid properties, such as density, specific gravity, viscosity, gas oil ratio (GOR), basic sediment and water (BSW), and the like. These measurements might not directly influence the whole testing process, but they can be used to monitor and quality control (QC) other acquired data. For example, monitoring BSW gives a very good indication of the end of well clean-up period.

Advantageously, the TDIP allows for the real-time monitoring, QC control and validation, processing, and visualization during the data acquisition process. The real-time data acquired during the test is imported to an interpretation and optimization toolbox. Starting from the existing reservoir model, which is built integrating all suitably available data (e.g., geology, geophysics, drilling, well logs, etc.), the effect of production is simulated using reservoir simulators at step 906 and the model parameters are accordingly adjusted to match the real-time reservoir behavior at steps 902-904 and 908-912. The benefit of real-time history matching of the reservoir behavior is reduction of the uncertainty range in reservoir parameters. As the test continues and the uncertainties are narrowed down, the test can be re-designed and the test program can be revised accordingly to the dynamic data acquired. The test is then continued until the achievement of all the objectives.

Apart from the application of real-time data in interpretation and optimization process, the data are also used in a standard well test analysis toolbox for diagnostic purposes. Accurate tracking of the rate and pressure data makes it possible to diagnose different flow regimes.

Accordingly, various processes are integrated in the TDIP workflow of FIGS. 9-13, and which cover a wide range of applications from quality assurance (QA)/QC of the input data, to the non-linear optimization techniques and automated reservoir simulation tools. For example, in the Reservoir Simulator step 906 of FIG. 9, the TDIP establishes links to both analytical and numerical reservoir simulators. Analytical reservoir simulators are used for the cases in which the reservoir has been known and there is not a great deal for uncertainties in reservoir and fluid properties, and wherein standard procedure of well testing can be employed. Numerical reservoir simulators are employed for more complex cases, for example, for unknown and uncertain reservoir and model parameters, and where a more detailed reservoir model is employed to perform more accurate and certain interpretations.

The Automatic Model Generator step 904 of FIG. 9 is employed and integrated in the TDIP because of its frequent use in both design and optimization sections. In design step of the test, the automatic model generator step 904 generates different realizations of the expected reservoir model based on a random sampling of the expected reservoir model, and reservoir and fluid properties. In the optimization section, the model generator step 1304 constructs the reservoir model based on the property improvements resulting from a non-linear parameter optimization process.

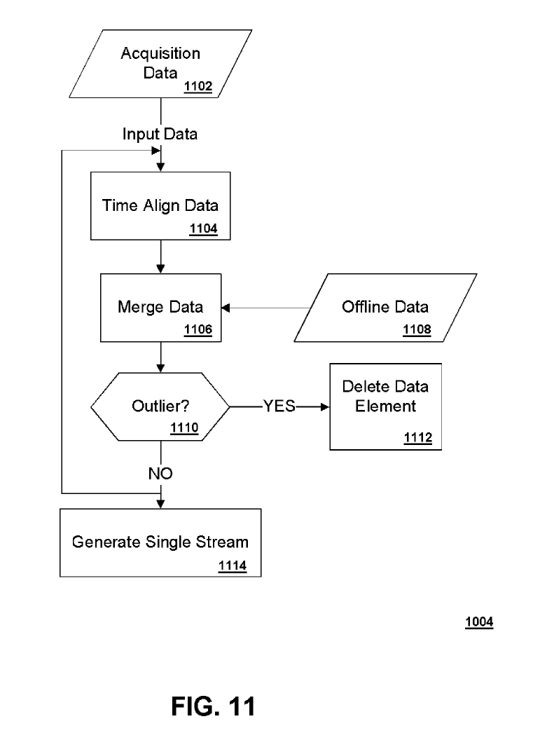

The Data QA/QC step 1004 of FIGS. 10A and 11 handles connecting/loading of data that can be from different sources. The main data entries for the TDIP are pressures and flow rates (e.g., dynamic data), and well, reservoir fluid and rock properties. In addition to data input prior to the test and the data inflow during the test, there are data generated as a result of computation processes in the reservoir simulator step 906 and reservoir model updates in step 904. These data are used as an input to other stages of calculation and optimization and therefore are subjected to the QA/QC step 1004 as well. Data input as a result of new information about the reservoir model and reservoir fluids properties also are subjected to the QA/QC step 1004. Accordingly, any suitable updated data is subjected the quality check process of step 1004.

The QA/QC process step 1004 also provides a methodology for data interpreters to have good understanding on the general data quality, testing sequences and events, and optimization and history matching (e.g., interpretation) steps. This methodology, advantageously, allows proper performance of the Data Processing step 1006. Accordingly, the advantage of the QA/QC process step 1004 is to allow one to diagnose and understand the wellbore, formation and/or tool related issues, during the test and failures of the simulator or optimization steps during the optimization process.

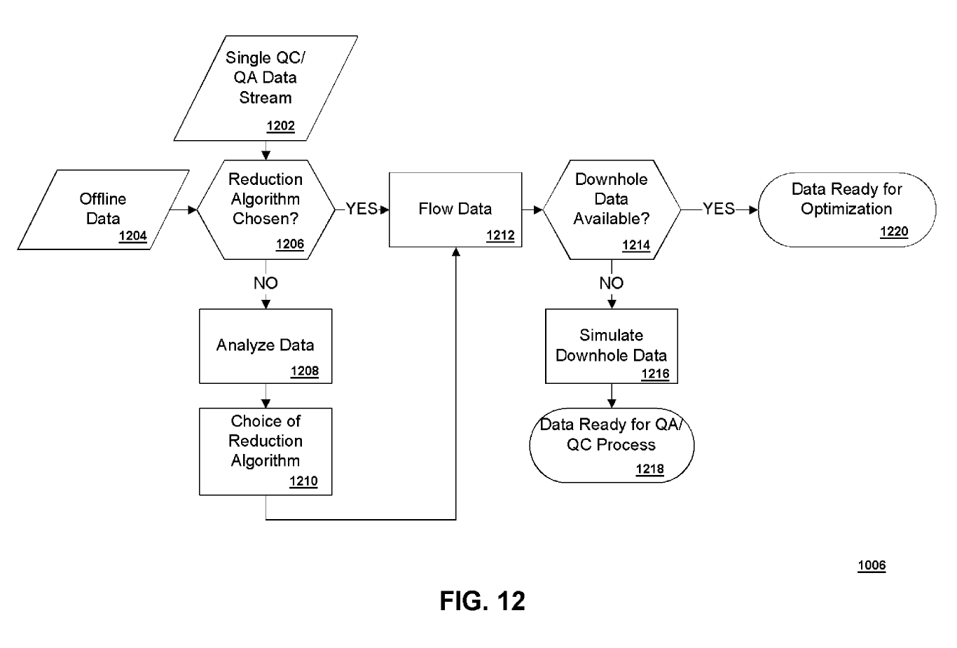

The Data Processing process step 1006 of FIGS. 10B and 12 minimizes the TDIP interpretation and computer execution time, advantageously, guaranteeing that the dynamic formation and well behavior is completely captured. The Data Processing step 1006 tasks can include removing unessential data, reducing high frequency and other noise, data smoothing (e.g., for zigzag data), reconstructing missing information, and the like.

In order to minimize the non-linear regression execution time, the actual data points used in the non-linear parameter estimation process can be reduced to a manageable number of data points. Given today's computing capabilities, it is generally accepted that less than a thousand dynamic data points are sufficient to perform parameter estimation, without missing any suitable well and formation information. A data reduction procedure, for example, based on any suitable signal processing algorithms, and the like, can be used for this purpose.

A flexible flow rate handling (e.g., smoothing, interpolating, or any other suitable signal processing, etc.) can be a part of the data processing step 1006, because even in the case of accurate measurement of the flow rates, keeping a constant flow rate is not simple and normally one deals with noisy flow rate data. Advantageously, the TDIP provides the user with an efficient processing and validation module for the flow rates of the reservoir fluids.

A diagnostic log-log pressure derivative plot is used to check the quality of data processing step 1006 and the degree of data decimating. Advantageously, the data processing step 1006 is thorough enough so as not to distort well and formation pressure transient characteristic, such as semi-log and log-log derivative, for the system identification, and a proper reduction of pressure data is performed considering synchronization thereof with the rate data.

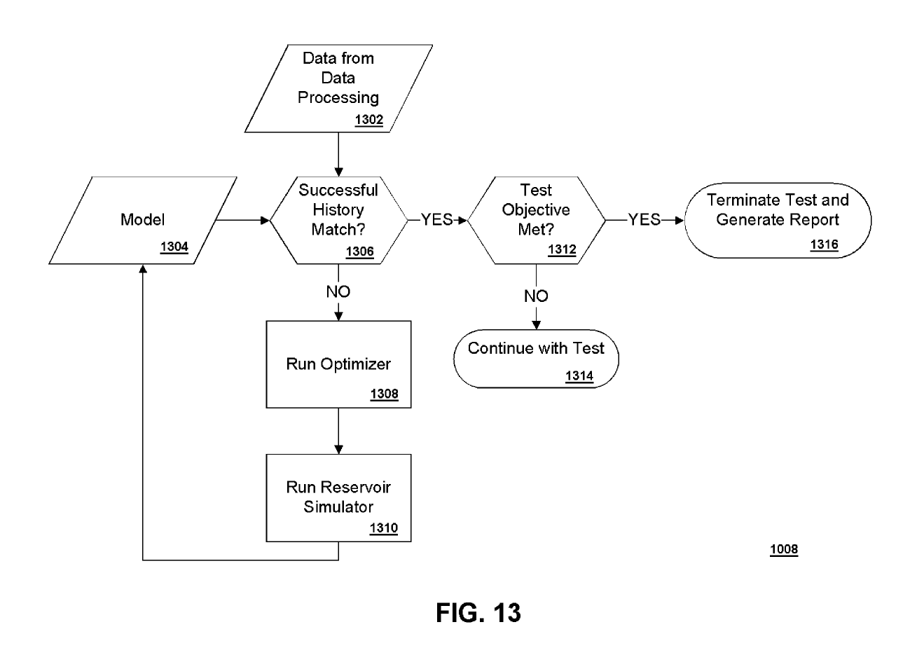

The Reservoir Modeling/Interpretation process step 1008 of FIGS. 10B and 13 employs pressure transient flow regimes for model identification and flow regime analysis. For example, a stabilized derivative on the log-log plot is an indication of the infinite acting radial flow. In addition, identification of the system provides invaluable information about boundaries, fractures, faults, and the like. A transient flow regime analysis can be performed by using the semi-log and log-log plots of either pressure changes or derivatives. For example, a flat (e.g., zero) slope might appear in the derivative curve of the log-log plot, which might suggest the existence of the infinite-acting radial flow regime.

It is recognized that for many reservoir models, there exists a characteristic pressure behavior which can be identified based on the log-log plot of pressure derivative. This could be a great help to interpretation and test engineers in deciding which model to use, simply by observing this plot. However, special attention should be given to the fact that occurrence of a specific characteristic signature depends on the corresponding flow regime. For example, appearance of the wellbore storage effect is normally known as an early time behavior, while the effect of a boundary (or boundaries) shows up in the late time response of the reservoir. Advantageously, diagnosis on the reservoir model is done within an appropriate time range to see its effects. In addition, the diagnosis performed on the test data, as the data is acquired, is performed in line with the well test objectives. For example, the test is not continued towards detection of a boundary, unless this is stated as a test objective.

Any suitable non-linear parameter optimization algorithm can be integrated in the TDIP in order to history-match the test pressure/rate data versus the outputs from reservoir simulator step 906. The optimization, advantageously, can be used to determine a reservoir model and reservoir properties that have the highest probability of providing real world behavior, as measured during the test, and under the same conditions of the test. The initial parameter estimates of reservoir and well parameters can include the mean value expected from other sources of information, gathered as input data.

The inverse problem of estimating unknown formation parameters of the previously constructed formation and well model can be formulated as a nonlinear optimization problem, which can be solved analytically or numerically. Parameter estimation can be performed by using weighted least square (WLS), for which weights are assumed to be known, or maximum likelihood estimation (MLE). The minimization of the objective functions can be achieved by using the Levenberg-Marquardt algorithm with a restricted step. In addition to the estimated parameters, statistical analysis of these parameters, including confidence interval and correlation coefficients, are computed using standard definitions or algorithms, and which are very useful for identifying which parameters can be determined reliably from the available data.

The present invention includes recognition that if the un-weighted least square (UWLS) estimation method is used for data sets having disparate orders of magnitude, then the data sets with large magnitudes will dominate those having small magnitudes in the estimation. Thus, information contained in data sets with small magnitudes will be lost. Also, in cases where some observations are less reliable than others, it is desirable to ensure that the parameter estimates will be less influenced by unreliable observations. To solve these and other problems, a WLS regression can be employed. Often, it is difficult to know the error variance structure and, thus, to determine the proper weights to be used in the WLS regression. Accordingly, an efficient optimization method based on the maximum likelihood estimation (MLE), advantageously, can be included into this workflow. The main advantage of the new method over the WLS method is that it eliminates the trial-and-error procedure required to determine appropriate weights to be used in the WLS estimation. This provides significant improvement in parameter estimation when working with pressure data sets of disparate orders of magnitude and noise.

The efficiency of the non-linear regression algorithm and the reliability of the parameter estimates from the non-linear optimization can be influenced by the initial selection of parameters and their constraints (or e.g., variations/ranges). Accordingly, in the TDIP workflow, the non-linear optimization is constrained by defining lower and upper limits for the parameters. In addition, pressure, permeability, skin factor, storage, and the like, can be estimated using an expected value with a range of distribution for each parameter. The initial properties of the constructed reservoir model are also constrained by using different sources of information.

Sometimes it is difficulty to obtain a reasonable match in a reservoir model with many unknowns after only one regression cycle. Therefore, an iterative procedure, where sometimes different processes of the TDIP workflow are employed, is used to constrain and enhance model and parameter estimation. In other words, uncertainties are reduced in the model and its estimated parameters by using the parameter estimates and statistics (e.g. confidence interval, correlation coefficients, etc.) from the previous regression as inputs. Advantageously, the reservoir model can be iteratively refined and its parameters can be iteratively adjusted. For example, the initial guess of parameters and their minimum and maximum ranges, the possible weights of each parameter, the number of parameters needed to be optimized, and the like, can be refined. At the end of each regression cycle, if the model and estimated parameters are accepted, then the modeling/interpretation process step 1008 is completed.

The Reporting process step 1010 of FIG. 10B is performed after termination of the test, when the meeting of the objectives is confirmed and the reservoir model is known within an acceptable range of uncertainty. The input, final, and intermediate results of calculation and history matching are exported to a reporting module of the reporting step 1010 to be used in a final well test report.

Thus, the workflow of the TDIP can include the design segment 900 of FIGS. 9-10A and the implementation and interpretation segments 1002-1010 of FIGS. 10A-13, and which can be integrated together. However, since the activities performed in design segment are done before execution of the test, the design segment can be independent and can be connected to the other segments through the initial model. Updates in initial model and/or the test program can be done in the implementation and interpretation segments.

The design procedure of FIG. 9 of the TDIP incorporates the opportunity to consider expected range of reservoir and fluid properties inputs (e.g., parameters containing uncertainty) and to generate a range of test duration outputs, for example, using a stochastic simulation. The output step 920 of the test design stage is a test program, which by 90% statistical certainty would guaranty achievement of the test objectives, advantageously, incorporating limitations in testing facilities (e.g., gauges, sensors, control devices, and surface hardware) in step 916. The output step 920, stream D(4a), is then used as an input to the modeling/interpretation block 1008 of the TDIP workflow shown in FIG. 10A-10B.

FIGS. 10A-10B thus represent an exemplary workflow of the TDIP. The interpretation and optimization steps 1002-1008 provide for an iterative process with iterations based on arrival of new information or data. New information is processed and interpreted, integrated with the old information, upon acquisition. The new interpretation results are compared with the test objectives and decision to continue data acquisition is made based on the achievement of the test objectives. The test is then terminated and report is generated at step 1010 when all test objectives are met and the range of certainty of the interpreted parameters is within acceptable range.

The TDIP can employ the concept of processes acting on data streams. The data streams are of several types and can be real time or near real time data streams, offline data streams, and the like. The further sub-classification of data streams, includes real time Critical or True Real Time (e.g., typically within milliseconds from an event) data streams and Non critical or Near Real Time (e.g., typically within seconds from an event) data streams, such as D(1); Offline data streams, such as D(2a); Continuous data streams, for example, created by an automated process; Manually created by data input and sporadic data streams, such as D(1); Aggregated data streams, including a combination of all suitable data stream types to create a consolidated stream type; and the like.

In the QA/QC Processing step 1004 of FIGS. 10A and 11, the TDIP workflow includes the processing of the various streams of near and real time data from different acquisition sources from step 1102. In step 1104, the data is time aligned to ensure that the timing of the data streams is synchronized. In step 1106, the data is combined with offline data either from an offline data stream or manually entered data from step 1108. The resulting aggregated data stream can then be analyzed automatically and/or manually, running quality assurance and quality checks in steps 1110-1112. For example, data elements including spikes or drifting measurement can be removed in steps 1110-1112. The resulting stream of data is an aggregated data stream D(2) from step 1114.

The Data Processing step 1006 of FIGS. 10B and 12, at step 1202, receives the data stream D(2) from step 1114 of the QA/QC process step 1004 and the offline data D(2a) at step 1204. The data processing step 1006 employs an automated process for the reduction or summarizing of the data at steps 1206-1220. When step 1214 determines that downhole measurements are not available, step 1216 produces simulated values D(3), as an offline automated stream, to represent the missing data or data that will arrive after the fact. At step 1218, the data D(3) is fed back to the process step 1004 as an additional data input. When the offline data D(2a) from other sources, such as pressure/volume/temperature (PVT) labs or data from recorded gauges is available, the data processing step 1006 can replace all or part of the simulated data with the data D(2a) to advantageously reduce the uncertainty of the result. At step 1220, the data D(4) ready for optimization is then provided to the modeling/interpretation process step 1008.

The Modeling/Interpretation process step 1008 of FIGS. 10B and 13, at step 1304, receives the initial model, for example, based on an initial simulation of expected conditions, using information from the nearby wells or any suitable geological study of the area, and the like, as data D(4a), from the process step 900. This serves as the initial model and with suitable assumptions. At step 1302, the data D(4) from the data processing process step 1006 is received and at steps 1306-1310 the modeling process 1008 iteratively updates the model with new arriving data. The modeling process 1008 with successive iterations also allows the deletion of certain assumptions, and is sent to the process 1006 as the data D(5), advantageously, allowing for a more robust interpretation. Steps 1312-1316 then determine if the test objectives are met and continue with the test or terminate the test for generating a report based on output data D(6).

The Reporting process step 1010 of FIG. 10B employs the data D(6) from the modeling process 1008 and at any suitable point in time offering a snapshot of the work with the data available at that point in time. When no more new data is available, the reporting process step 1010 provides the final result or data.

Advantageously, the TDIP platform of FIGS. 9-13 provides for a complete interpretation of the pressure transient and flow rate data, and can capture and analyze information at the end of the interpretation in a prompt, accurate, and efficient manner, with automation and visualization as an integral part of the platform. In the near future, real-time monitoring of the well and reservoir data will play a central role for well productivity and reservoir management. Thus, it is very important to respond timely to solve reservoir problems, and maintain well productivity and production. To ensure effective well monitoring, the TDIP can provide real-time interpretation, even as monitoring systems evolve continuously, and can highlight the interpretation significance of wells being monitored.

The above-described devices and subsystems of the exemplary embodiments of FIGS. 9-13 can include, for example, any suitable servers, workstations, personal computers (PCs), laptop computers, personal digital assistants (PDAs), Internet appliances, handheld devices, cellular telephones, wireless devices, other electronic devices, and the like, capable of performing the processes of the exemplary embodiments of FIGS. 9-13. The devices and subsystems of the exemplary embodiments of FIGS. 9-13 can communicate with each other using any suitable protocol and can be implemented using one or more programmed computer systems or devices.

One or more interface mechanisms can be used with the exemplary embodiments of FIGS. 9-13, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 9-13 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 9-13 can be implemented via one or more programmed computer systems or devices.

To implement such variations as well as other variations, a single computer system can be programmed to perform the special purpose functions of one or more of the devices and subsystems of the exemplary embodiments of FIGS. 9-13. On the other hand, two or more programmed computer systems or devices can be substituted for any one of the devices and subsystems of the exemplary embodiments of FIGS. 9-13. Accordingly, principles and advantages of distributed processing, such as redundancy, replication, and the like, also can be implemented, as desired, to increase the robustness and performance the devices and subsystems of the exemplary embodiments of FIGS. 9-13.

The devices and subsystems of the exemplary embodiments of FIGS. 9-13 can store information relating to various processes described herein. This information can be stored in one or more memories, such as a hard disk, optical disk, magneto-optical disk, RAM, and the like, of the devices and subsystems of the exemplary embodiments of FIGS. 9-13. One or more databases of the devices and subsystems of the exemplary embodiments of FIGS. 9-13 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 9-13 can include appropriate data structures for storing data collected and/or generated by the processes of the devices and subsystems of the exemplary embodiments of FIGS. 9-13 in one or more databases thereof.

All or a portion of the devices and subsystems of the exemplary embodiments of FIGS. 9-13 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 9-13 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 9-13, for driving the devices and subsystems of the exemplary embodiments of FIGS. 9-13, for enabling the devices and subsystems of the exemplary embodiments of FIGS. 9-13 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 9-13. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 9-13 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present inventions have been described in connection with a number of exemplary embodiments, and implementations, the present inventions are not so limited, but rather cover various modifications, and equivalent arrangements, which fall within the purview of the appended claims.

What is claimed is:

1. A system for well test design and interpretation, the system comprising:
a testing manager system, including at least one of testing hardware and gauge metrology;
a geological model coupled to the testing manager system;
a dynamic and static engineering data acquisition system coupled to the geological model; and
a reservoir modeling system coupled to the dynamic and static engineering data acquisition system to generate a reservoir response.

2. The system of claim 1, wherein the testing hardware and gauge metrology includes one or more sensors for measurement of at least one of well downhole pressure, well surface pressure, well temperature, and well flow rate.

3. The system of claim 1, wherein the testing hardware and gauge metrology includes at least one of a multiphase meter for measuring the flow rate and the water, oil and gas fraction of the well effluent, drillstem testing (DST) system, a reservoir interference test system, a permanent downhole pressure system, and a distributed pressure gauge, including smart plugs or smart casing.

4. The system of claim 1, wherein the geological model is based on at least one of seismic information, petrophysics, geology and well correlation data, and logging while drilling (LWD) data and geosteering model.

5. The system of claim 1, wherein the dynamic and static engineering data acquisition system employs at least one of production logging tool (PLT) data, core analysis tool data, Special Core Analysis (SCAL) tool data, pressure-volume-temperature (PVT) tool data, and well completions tool data.

6. The system of claim 1, wherein the reservoir modeling system includes at least one of an analytical simulator, and a numerical simulator.

7. The system of claim 1, further comprising a test operation and data acquisition system, including at least one of test sequence and test design modifications, data sampling, processing and visualization, and data quality control (QC) and validation.

8. The system of claim 1, further comprising a real-time wellsite and remote site interpretation system, including at least one of model identification, diagnostic and flow regime analysis, refining of the reservoir model and parameters thereof including at least one of initialization, conditioning, calibrating, scaling, range, and weight assigning, and nonlinear parameter estimation including history matching and based on at least one of analytical and numerical solutions of the reservoir model and at least one of least squares (L-S) and maximum likelihood (ML) regression techniques,
wherein the real-time wellsite and remote site interpretation system is configured to generate a final estimate of parameters including at least one of confidence interval and statistical analysis, and is further configured to terminate testing and reporting.

9. The system of claim 1, further comprising a final analysis system, including at least one of verification, uncertainty analysis, nodal analysis, and reserves estimation, based on at least one of refining of the reservoir model and parameters thereof, nonlinear parameter estimation based on at least one of analytical and numerical solutions of the reservoir model and at least one of least squares (L-S) and maximum likelihood (ML) regression techniques, nodal analysis, decline curve analysis, and validation of volumetric oil in place and material balance,
wherein the final analysis system is configured to generate a final report.

10. The system of claim 1, wherein the system is configured for making decisions related to well production efficiency, well operations, well safety, well workover, and well reservoir management based on the measurements of the well downhole pressure, well surface pressure, well temperature, and well flow rate in real-time.

11. The system of claim 1, wherein the system is configured for acquiring data continuously from the testing hardware and gauge metrology with downhole pressure measurements for real time interpretation for optimizing at least one of well completion, perforation, lift, production, and recovery.

12. The system of claim 1, wherein the system is configured for synthesizing well test measurements, including at least one of pressure, flow rate, and temperature with the geological model to model such measurements and anticipate an encounter of geological features, including at least one of faults, and fractures, during testing, in order not to terminate well testing prematurely.

13. The system of claim 1, wherein the system is configured for continuously updating the reservoir model as data is received,
wherein the testing manager provides real-time connections to at least one design, interpretation, and toolboxes.

14. A method for well test design and interpretation, the method comprising the steps of:
generating a test plan and an initial reservoir model based on at least one of an expected reservoir model, reservoir properties, reservoir fluid properties, and metrology;
generating data streams based on the test plan from at least one of real-time, near-real-time, surface, downhole, and manual data sources;
generating an aggregated data stream based on quality control or assurance on the data streams;
generating data for optimization based on the aggregated data stream and simulated downhole data sent to the quality control or assurance;
modeling or interpreting of the optimization data including reservoir simulation and modeling to determine if test objectives are met for terminating or continuing the test plan and generating data sent to the generating data for optimization for modifying assumptions therein; and
reporting data received from the modeling or interpretation when terminating the test plan.

15. A computer program product for well test design and interpretation and including one or more computer readable instructions embedded on a computer readable medium and configured to cause one or more computer processors to perform the steps of the method of claim 14.
